(19) United States
(12) Patent Application Publication
(10) Pub. No.: US 2006/0145959 A1
(43) Pub. Date: Jul. 6, 2006

(54) Plasma display apparatus and driving method thereof

(75) Inventor: Jeong Pil Choi, Gyeonggi-do (KR)

Correspondence Address: BIRCH STEWART KOLASCH & BIRCH, PO BOX 747, FALLS CHURCH, VA, 22040-0747, US

(73) Assignee: LG Electronics Inc.

(21) Appl. No.: 11/296,425

(22) Filed: Dec. 8, 2005

(30) Foreign Application Priority Data
Dec. 30, 2004 (KR) 10-2004-0117405

(51) Int. Cl. G09G 3/28

(52) U.S. Cl. 345/68

(57) ABSTRACT

The present invention relates to a plasma display apparatus and a driving method thereof. The plasma display apparatus according to the present invention comprises a plasma display panel for displaying an image, and a plurality of energy recovery circuit for supplying sustain pulses to the plasma display panel, wherein each of the plurality of energy recovery circuit supplies the sustain pulses to the plasma display panel independently to the sustain period of the different sub-field.

This Nonprovisional application claims priority under 35 U.S.C. § 119(a) on Patent Application No. 10-2004-0117405 filed in Korea on Dec. 30, 2004 the entire contents of which are hereby incorporated by reference.

### BACKGROUND OF THE INVENTION

1. Field of the Invention

The present invention relates to a plasma display apparatus and a method of driving thereof.

2. Description of the Background Art

In general, a plasma display panel (hereinafter referred to as a PDP) displays images comprising characters or graphics by exciting phosphors to emit light using 147 nm ultraviolet generated during discharging inert mixture gas, such as He+Xe mixture or Ne+Xe mixture.

FIG. 1 is a prospective view illustrating a structure of a conventional 3-electrode AC surface discharge type PDP.

Referring to FIG. 1, the three-electrode AC surface discharge PDP comprises a scan/sustain electrodes 11 and a sustain electrode 12 formed on an upper substrate 10 and an address electrode 22 formed on a lower substrate 20. Each of the scan/sustain electrodes 11 and the common sustain electrode 12 is made of, for example, Indium-Tin-Oxide (ITO). The scan/sustain electrodes 11 and common sustain electrodes 12 are respectively formed with metal bus electrodes 11b, 12b for reducing resistance. An upper dielectric layer 13a and a protection film 14 are applied to the upper substrate 10 on which the scan/sustain electrodes 11 and common sustain electrodes 12 are formed. Wall charges created during plasma discharge are accumulated on the upper dielectric layer 13a. The protection film 14 prevents the upper dielectric layer 13a from being damaged due to sputtering caused by plasma discharge and increases the emission efficiency of the secondary electrons. The protection film 14 is generally made of MgO.

Meanwhile, a lower dielectric layer 13b and barrier ribs 21 are formed on the lower substrate 20 on which the address electrodes 22 are formed, and a phosphor layer 23 is applied to the surface of the lower dielectric layer 13b and the barrier ribs 21. The address electrodes 22 are arranged in a direction intersecting the scan/sustain electrodes 11a and common sustain electrodes 12a. The barrier ribs 21 are formed in parallel to the address electrodes 22, so to prevent ultraviolet and visible light generated by discharge from leaking to neighboring discharge cells. The phosphor layer 23 is excited by ultraviolet generated by the plasma discharge, thus emitting any one of Red, Green, and Blue colors. Discharge spaces of discharge cells formed between the upper and lower substrates 10 and 20 and the barrier ribs 21 are filled with inert mixture gas, such as He+Xe or Ne+Xe. Now, a driving apparatus of the conventional PDP with the structure described above will be described with reference to FIG. 2.

FIG. 2 is a view illustrating a driving apparatus of a conventional AC surface discharge type PDP.

Referring to FIG. 2, the driving apparatus of the conventional AC surface discharge type PDP comprises a PDP in which m×n discharge cells 1 are arranged in the matrix type so that they are connected to the scan/sustain electrode lines Y1 to Ym, the common sustain electrode lines Z1 to Zm, and the address electrode lines X1 to Xn, a scan/sustain driver 102 for driving the scan/sustain electrode lines Y1 to Ym, a common sustain driver 104 for driving the common sustain electrode lines Z1 to Zm, and a data driver 106 for driving the address electrode lines X1 to Xn. The scan/sustain driver 102 sequentially supplies scan pulses and sustain pulses to the scan/sustain electrode lines Y1 to Ym to cause the discharge cells 1 to be sequentially scanned on line basis and at the same time to cause the discharge to be sustained in each of m×n discharge cells. The common sustain driver 104 supplies the sustain pulses to all of the common sustain electrode lines Z1 to Zm. The address driver 106 supplies the image data to the address electrode lines X1 to Xn to be synchronized with the scan pulses.

Meanwhile, the AC surface discharge type PDP driven as mentioned above requires a high voltage of above several hundred volts for the sustain discharge. Thus, an energy recovery circuit is added to the scan/sustain driver 102 and common sustain driver 104 to minimize the drive power required for the sustain discharge. The energy recovery circuit recovers the voltage charged to the scan/sustain electrode line Y and common sustain electrode line Z, and reuses it as a drive voltage for subsequent discharge.

FIG. 3 is a view illustrating an energy recovery circuit installed to recover the conventional sustain discharge voltage.

Referring to FIG. 3, the conventional energy recovery circuit comprises an energy supply/recovery unit 108 and a sustain voltage source unit 110. The energy supply/recovery unit 108 has an inductor L connected between a panel capacitor Cp and a source capacitor Cs, and a first and a second switches S1, S2 connected in parallel between the source capacitor Cs and the inductor L. In addition, a first and a second diodes are connected to the ends of the first and the second switches, respectively. The sustain voltage source unit 110 is consist of a third and a fourth switches S3, S4 connected in parallel between the panel capacitor Cp and the inductor L. The capacitance of the panel capacitor Cp is equal to that formed between the scan/sustain electrode line Y and the common sustain electrode line Z. The second switch S3 is connected to the sustain voltage source Vsus, and the fourth switch S4 is connected to the base voltage source GND. The source capacitor Cs recovers and charges the voltage charged to the panel capacitor Cp during the sustain discharge, and at the same resupplies the charged voltage to the panel capacitor Cp. The source capacitor Cs has a sufficiently great capacitance to be capable of charging the voltage of Vsus/2 corresponding to the half value of the sustain voltage Vsus. The inductor L forms a resonant circuit with the panel capacitor Cp. The first to fourth switches S1 to S4 control the flow of current. The energy recovery circuit provided in the common sustain driver 104 is formed symmetrically with the scan/sustain driver 102 with respect to the panel capacitor Cp.

Meanwhile, conventionally, the real configuration of the energy recovery circuit installed to recover the discharge voltage does not comprise only the third and fourth switches S3, S4 connected in parallel between the panel capacitor Cp and the inductor L, but comprises a plurality of switching elements in parallel with one another as shown in FIG. 4.

FIG. 4 is a view illustrating a real energy recovery circuit installed to recover the conventional sustain discharge voltage, and FIG. 5 is a view illustrating the parallel connection configuration of the switching elements in the energy recovery circuit shown in FIG. 4.

Referring to FIGS. 4 and 5, the real energy recovery circuit has a plurality of switching elements in the sustain voltage source unit 110 to generate a sustain discharge with supplying the sufficient current. The plurality of switching elements S31, . . . , S3n, S41, . . . , S4n, which generally have a small current carrying capacity, are connected in parallel between the panel capacitor Cp and the inductor L. As such, the plurality of switching elements S31, . . . , S3n, S41, . . . , S4n having a small current carrying capacity can further reduce the resistance than the single unit of switching element having a great current carrying capacity and the number of parts is increased, thus having a great advantage in the exothermic property.

Meanwhile, as the plasma display apparatus is large-sized, it should be designed so that the number of the power switching elements is increased accordingly. Therefore, although the number of errors of the parts is small, the problems such as the concentration of the heat generation on the parts, the increase of consumption power, the breakage of parts, etc. arise since the errors of the parts are accumulated.

### SUMMARY OF THE INVENTION

Accordingly, an object of the present invention is to solve at least the problems and disadvantages of the background art.

An object of the present invention is to provide a plasma display apparatus and a driving method thereof which can improve the imbalance of the exothermic property in switching elements upon driving the plasma display panel.

In addition, another object of the present invention is to provide a plasma display apparatus and a driving method thereof which can improve the imbalance of the current property due to the part deviation of switching elements upon driving the plasma display panel.

A plasma display apparatus according to the present invention comprises a plasma display panel for displaying an image, and a plurality of energy recovery circuit for supplying sustain pulses to the plasma display panel, wherein each of the plurality of energy recovery circuit supplies the sustain pulses to the plasma display panel independently to the sustain period of the different sub-field.

A plasma display apparatus according to the present invention comprises a plasma display panel for displaying an image, wherein the plasma display panel comprises a plurality of energy recovery circuits, each of the plurality of energy recovery circuit supplies the sustain pulses to the plasma display panel independently to the sustain period of the same sub-field.

A driving method of a plasma display apparatus according to the present invention, wherein sustain pulses are supplied to a plasma display panel independently to the sustain period of the different sub-fields among the sub-fields.

The present invention can prevent the current cancel by prohibiting the phase difference of the current of the sustain pulses provided to the plasma display panel.

In addition, the present invention can improve the imbalance of current property or exothermic property due to the parts deviation and the difference of drive property upon driving the plasma display panel.

### BRIEF DESCRIPTION OF THE DRAWINGS

The invention will be described in detail with reference to the following drawings in which like numerals refer to like elements.

FIG. 1 is a prospective view illustrating a structure of a conventional 3-electrode AC surface discharge type PDP.

FIG. 2 is a view illustrating a driving apparatus of a conventional AC surface discharge type PDP.

FIG. 3 is a view illustrating an energy recovery circuit installed to recover the conventional sustain discharge voltage.

FIG. 4 is a view illustrating a real energy recovery circuit installed to recover the conventional sustain discharge voltage.

FIG. 5 is a view illustrating the parallel connection configuration of the switching elements in the energy recovery circuit shown in FIG. 4.

FIG. 6 is a view illustrating a plasma display apparatus according to the present invention.

FIG. 7 is a view of an energy recovery circuit of A plasma display apparatus according to a first embodiment of the present invention.

FIG. 8 is a view for illustrating a driving method of an energy recovery circuit according to a first embodiment of the present invention.

FIG. 9 is a view of an energy recovery circuit of a plasma display apparatus according to a second embodiment of the present invention.

FIG. 10 is a view for illustrating a driving method of an energy recovery circuit according to a second embodiment of the present invention.

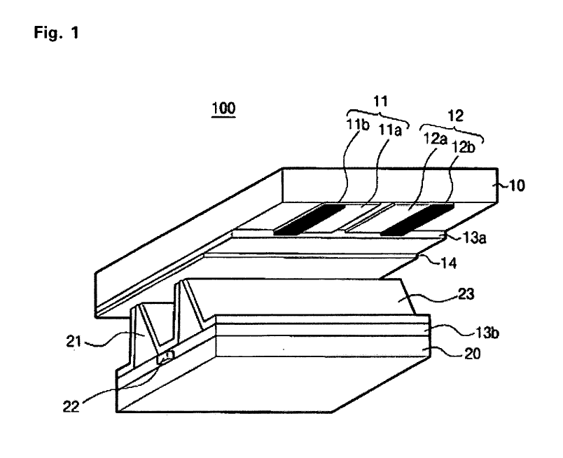

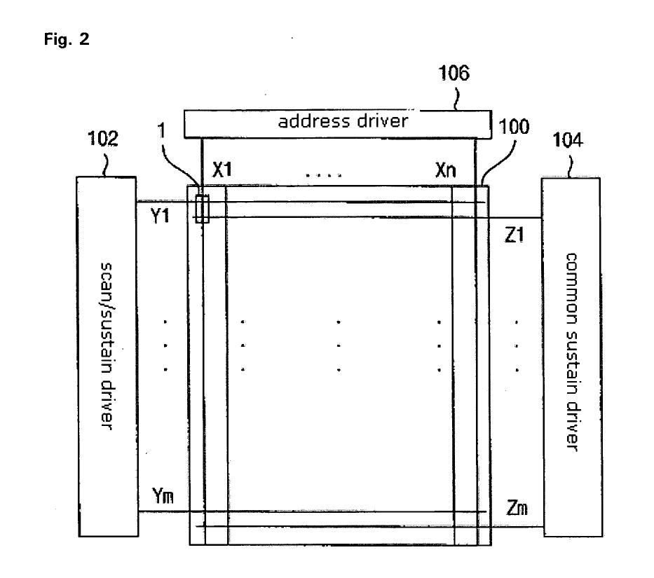

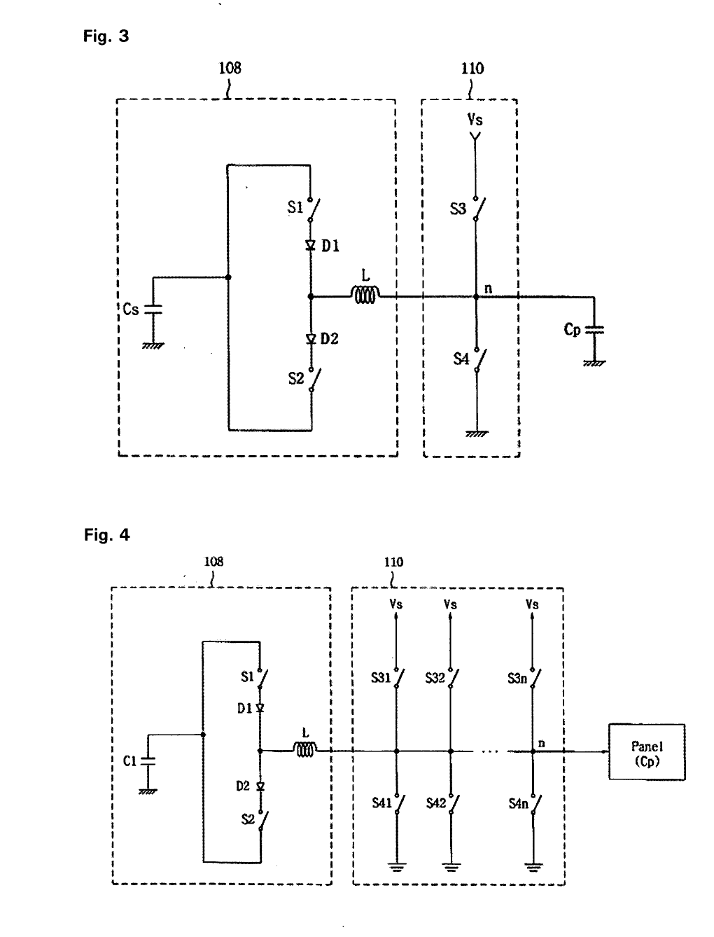

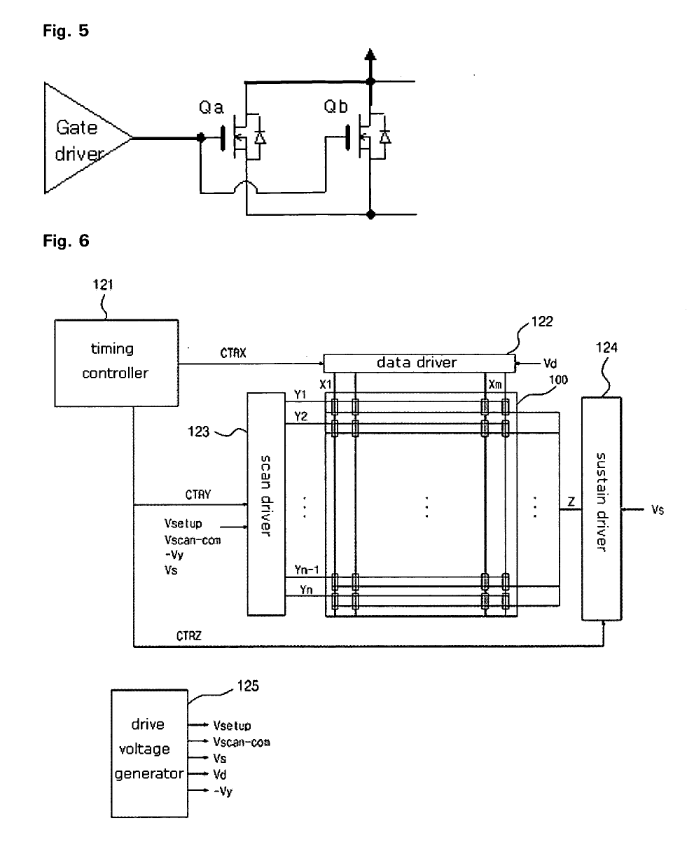

### DETAILED DESCRIPTION OF PREFERRED EMBODIMENTS

Preferred embodiments of the present invention will be described in a more detailed manner with reference to the drawings.

A plasma display apparatus according to the present invention comprises a plasma display panel for displaying an image, and a plurality of energy recovery circuit for supplying sustain pulses to the plasma display panel, wherein each of the plurality of energy recovery circuit supplies the sustain pulses to the plasma display panel independently to the sustain period of the different sub-field.

The plurality of energy recovery circuit is composed of a first and a second energy recovery circuits, the first energy recovery circuit supplies sustain drive pulses to the plasma display panel in a sustain period of the order-numbered sub-fields, the second energy recovery circuit supplies sustain drive pulses to the plasma display panel in a sustain period of the even-numbered sub-fields.

A plasma display apparatus according to the present invention comprises a plasma display panel for displaying an image, wherein the plasma display panel comprises a plurality of energy recovery circuits, each of the plurality of energy recovery circuit supplies the sustain pulses to the plasma display panel independently to the sustain period of the same sub-field.

The number of the plurality of energy recovery circuit is two.

The plurality of energy recovery circuit is composed of a first and a second energy recovery circuits, the first energy recovery circuit supplies the order-numbered sustain drive pulses to the plasma display panel in a sustain period of the sub-field, the second energy recovery circuit supplies the even-numbered sustain drive pulses to the plasma display panel in a sustain period of the sub-field.

The sustain drive pulse input end of the first energy recovery circuit and the sustain drive pulse input end of the second energy recovery circuit are commonly connected to each other and in turn connected to the plasma display panel.

The energy recovery circuit comprises an energy supply/recovery unit for supplying and recovering the energy to the plasma display panel, and an sustain voltage source unit comprising a sustain voltage source, a third switch group and a fourth switch group so that the plasma display panel is applied with a sustain voltage and a ground level voltage.

The third switch group and the fourth switch group are connected in parallel between the plasma display panel and the energy supply/recovery unit.

The energy supply/recovery unit comprises an inductor for supplying and recovering through the resonance the energy stored in the source voltage source of the plasma display panel, and a first switch group and a second switch group for performing a switching operation so that the energy is supplied and recovered to the plasma display panel through the inductor.

The first switch group and the second switch group are connected in parallel between the source voltage source and the inductor.

A driving method of a plasma display apparatus according to the present invention, wherein sustain pulses are supplied to a plasma display panel independently to the sustain period of the different sub-fields among the sub-fields.

Hereafter, the embodiments will be described in more detailed with reference to the accompanying drawings.

FIG. 6 is a view illustrating a plasma display apparatus according to the present invention. Referring to FIG. 6, the plasma display apparatus according to the present invention comprises a plasma display panel 100, a data driver for supplying data to address electrodes X1 to Xm formed on a lower substrate (not shown) of the plasma display panel 100, a scan driver 123 for driving scan electrodes Y1 to Yn, a sustain driver 124 for driving sustain electrodes Z being common electrodes, a timing controller 121 for controlling the data driver 122, the scan driver 123, and the sustain driver 124 upon driving the plasma display panel, and a drive voltage generator 125 for supplying the drive voltage needed in each driver 122, 123, 124.

An upper substrate (not shown) and a lower substrate (not shown) in the plasma display panel 100 are combined with each other while maintaining a predetermined distance. And the upper substrate is formed with pairs of scan electrodes Y1 to n and sustain electrode Z, and the lower substrate is formed with address electrodes X1 to Xm so that the address electrodes X1 to Xm intersect the scan electrodes Y1 to Yn and sustain electrode Z.

The data are inverse gamma corrected and error diffused by an inverse gamma correction circuit, an error diffusion circuit, etc and then the data mapped by a sub-field mapping circuit are supplied in the data driver 122. The data driver 122 samples and latches the data responding to the timing control signal CTRX from the timing controller 121, and then supplies the data to the address electrodes X1 to Xm.

The scan driver 123 supplies a rising ramp waveform Ramp-up and a falling ramp waveform Ramp-down to the scan electrodes Y1 to Yn under control of the timing controller 121 during the reset period. In addition, the scan driver 123 sequentially supplies the scan pulses Sp of the scan voltage −Vy to the scan electrodes Y1 to Yn under control of the timing controller 121 during the address period, and supplies the sustain pulse raised to the sustain voltage to the scan electrodes Y1 to Yn comprising the plurality of energy recovery circuits (not shown) during the sustain period.

The sustain driver 124 supplies the sustain pulses sus to the sustain electrodes Z comprising the plurality of energy recovery circuits (not shown) under control of the timing controller 121 during the sustain period similarly to the scan driver 123. At this time, the plurality of energy recovery circuits comprised in the sustain driver 124 have a same construction as that of the energy recovery circuit comprised in the scan electrode driver 123, and they are operated alternately to the plurality of energy recovery circuits comprised in the scan electrode driver 123.

The timing controller 121 receives vertical/horizontal synchronization signals and a clock signal, generates timing control signals CTRX, CTRY, CTRZ to control the operation timing and synchronization of each driver 122, 123, 124 and the sustain pulse control unit 126 in the reset, address, and sustain periods, and supplies the timing control signals CTRX, CTRY, CTRZ to the corresponding drivers 122, 123, 124 to thereby control the each driver 122, 123, 124.

The data control signal CTRX includes a sampling clock for sampling the data, a latch control signal, and a switch control signal for controlling the on/off times of the energy recovery circuit and drive switch element. The scan control signal CTRY comprises a switch control signal for controlling the on/off times of the drive switch element and the energy recovery circuit in the scan driver 123, and the sustain control signal CTRZ includes a switch control signal for controlling the on/off times of the drive switch element and the energy recovery circuit in the sustain driver 124.

The drive voltage generator 125 generates a set up voltage Vsetup, a scan common voltage Vscan-com, a scan voltage −Vy, a sustain voltage Vs, and a data voltage Vd. Such drive voltages can be altered according to the composition of the discharge gases, or the construction of the discharge cell.

Although the scan driver and the sustain driver are independently formed in the plasma display apparatus according to the present invention, both of them may be formed as one integrated driver. At this time, the energy recovery circuit is comprised in the integrated driver.

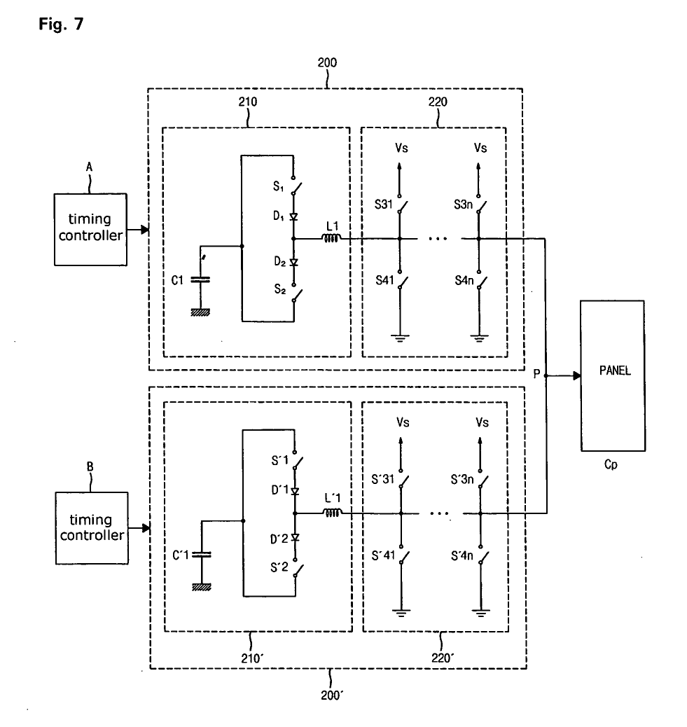

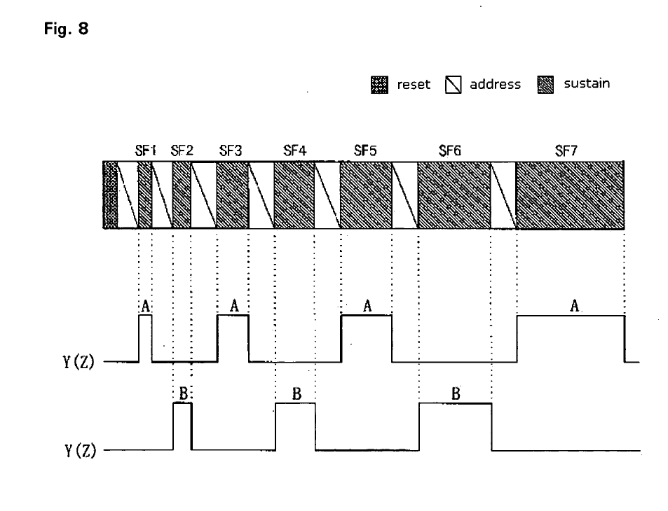

FIG. 7 is a view of an energy recovery circuit of A plasma display apparatus according to a first embodiment of the present invention, and FIG. 8 is a view for illustrating a driving method of an energy recovery circuit according to a first embodiment of the present invention.

Firstly, the energy recovery circuit, which is formed in plurality, is comprised in at least either of the scan driver or sustain driver, which is not shown in drawings. The plurality of energy recovery circuits is preferably composed of a first energy recovery circuit 200 and a second energy recovery circuit 200′, as shown in FIG. 7.

The first energy recovery circuit 200 and the second energy recovery circuit 200′ comprises an energy supply/recovery unit 210, 210′ and a sustain voltage source unit 220, 220′, respectively, similarly to the conventional energy recovery circuit.

The energy supply/recovery unit 210 of the first energy recovery unit 200 has an inductor L1 connected between a panel capacitor Cp being the plasma display panel and a source capacitor C1 being source voltage source, a first switch S1 and a second switch S2 and a first diode D1 and a second diode D2 connected in parallel between the source capacitor C1 and the inductor L1. The first switch S1 and the first diode D1, and the second switch S2 and the second diode D2 are connected in series to each other, respectively. Each source capacitor C1, which has a capacitance being capable of charging the voltage of Vs/2 corresponding to half value of the sustain voltage Vs, recovers and charges the voltage charged in each region of the panel capacitor Cp during the sustain discharge, and at the same time resupplies the charged voltage to each region of the panel capacitor Cp. At this time, the inductor L1 and the panel capacitor Cp form a resonant circuit.

In addition, the sustain voltage source unit 220 of the first energy recovery circuit 200 comprises a sustain voltage source Vs, a third switch group S31, S32, . . . , S3n, and a fourth switch group S41, S42, . . . , S4n. And the third switch group S31, S32, . . . , S3n, and the fourth switch group S41, S42, . . . , S4n are connected in parallel between the panel capacitor Cp being the plasma display panel and the inductor L1. In addition, the third switch group S31, S32, . . . , S3n is connected to the sustain voltage source Vs, and the fourth switch group S41, S42, . . . , S4n is connected to the base voltage source GND.

A energy supply/recovery unit 210′ and a sustain voltage source unit 220′ of a second energy recovery circuit 200′ also have a similar construction to the energy supply/recovery unit 210 and the sustain voltage source unit 220 of the first energy recovery circuit 200.

The energy recovery circuit according to the first embodiment of the present invention supplies the sustain pulses to the plasma display panel during the sustain period upon driving the plasma display apparatus. At this time, the sustain pulses supplied by the first and the second energy recovery circuits 200, 200′ are independently supplied to the plasma display panel Cp, respectively, by the timing controller A, B for controlling the timing of the drive pulses. That is, the first and the second energy recovery circuits 200, 200′, respectively, supply the independent sustain drive pulses to the plasma display panel in the sustain period of the different sub-field upon driving the plasma display panel.

More specifically, the first energy recovery circuit supplies the sustain drive pulses to the scan electrode Y or the sustain electrode Z of the plasma display panel in the sustain period of the odd-numbered sub-fields SF1, SF3, SF5 . . . , and the second energy recovery circuit supplies the sustain drive pulses to the scan electrode Y or the sustain electrode Z of the plasma display panel in the sustain period of the even-numbered sub-fields SF2, SF4, SF6 . . .

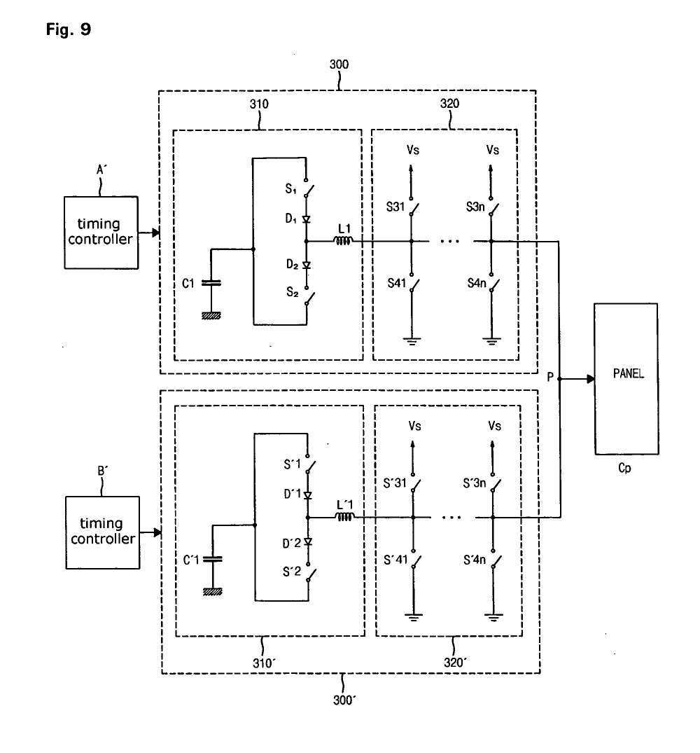

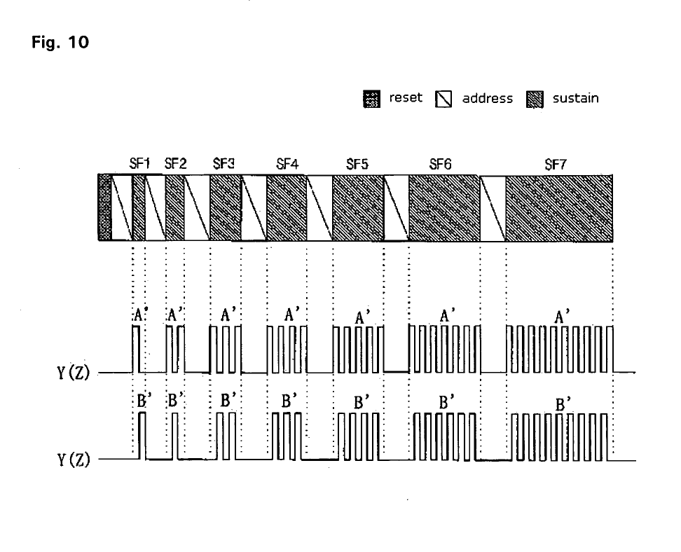

FIG. 9 is a view of an energy recovery circuit of a plasma display apparatus according to a second embodiment of the present invention, and FIG. 10 is a view for illustrating a driving method of an energy recovery circuit according to a second embodiment of the present invention.

The energy recovery circuit according to the second embodiment of the present invention is also comprised in at least either one of the scan driver or the sustain driver similarly to the first embodiment, and the energy recovery circuit is formed in plurality. The plurality of energy recovery circuits are preferably composed of a first energy recovery circuit 300 and a second energy recovery circuit 300′.

Each energy recovery circuit 300, 300′ has the same construction as that of each energy recovery circuit 200, 200′ according to the first embodiment of the present invention, and the detailed description will be omitted.

The energy recovery circuits 300, 300′ according to the second embodiment of the present invention supplies the sustain pulses to the plasma display panel during the sustain period upon driving the plasma display apparatus as shown in FIG. 10. At this time, the sustain pulses supplied by the first and the second energy recovery circuits 300, 300′ are independently supplied to the plasma display panel Cp, respectively, by the timing controller A′, B′ for controlling the timing of the drive pulses. That is, the first and the second energy recovery circuits 300, 300′, respectively, supply the independent sustain drive pulses to the plasma display panel in the sustain period of the same sub-field upon driving the plasma display apparatus.

More specifically, the first energy recovery circuit 300 supplies the odd-numbered sustain drive pulses Sus1, Sus3, Sus5 . . . to the scan electrode Y or the sustain electrode Z of the plasma display panel in the sustain period of the sub-field, and the second energy recovery circuit 300′ supplies the even-numbered sustain drive pulses Sus2, Sus4, Sus6 . . . to the scan electrode Y or the sustain electrode Z of the plasma display panel in the same sustain period of the sub-field as the time when the first energy recovery circuit is operated.

As such, the plasma display apparatus according to the first and second embodiments of the present invention can enhance the drive margin according to the supply of the sustain pulse as well as the drive properties such as the imbalanced current supply and the parts deviation of the switching element created according to the supply of the sustain pulses through one energy recovery circuit to the conventional entire plasma display panel, by independently of the plurality of energy recovery circuit supplying the energy to the plasma display panel upon driving the plasma display apparatus.

In addition, in the plasma display apparatus according to the first and second embodiments of the present invention, the output node P of the sustain pulse toward the plasma display panel Cp, i.e. the input end of the sustain drive pulse of the first energy recovery circuits 200, 300, and the input end of the sustain drive pulse of the second energy recovery circuits 200′, 300′ are commonly connected to each other. Thus, the current cancel can be prevented which can be created by the phase difference of the current.

The invention being thus described, it will be obvious that the same may be varied in many ways. Such variations are not to be regarded as a departure from the spirit and scope of the invention, and all such modifications as would be obvious to one skilled in the art are intended to be comprised within the scope of the following claims.

What is claimed is:

1. A plasma display apparatus comprising:
a plasma display panel for displaying an image; and
a plurality of energy recovery circuit for supplying sustain pulses to the plasma display panel, wherein
each of the plurality of energy recovery circuit supplies the sustain pulses to the plasma display panel independently to the sustain period of the different sub-field.

2. The plasma display apparatus as claimed in claim 1, wherein
the number of the plurality of energy recovery circuit is two.

3. The plasma display apparatus as claimed in claim 2, wherein
the plurality of energy recovery circuit is composed of a first and a second energy recovery circuits,
the first energy recovery circuit supplies sustain drive pulses to the plasma display panel in a sustain period of the order-numbered sub-fields,
the second energy recovery circuit supplies sustain drive pulses to the plasma display panel in a sustain period of the even-numbered sub-fields.

4. The plasma display apparatus as claimed in claim 3, wherein
the sustain drive pulse input end of the first energy recovery circuit and the sustain drive pulse input end of the second energy recovery circuit are commonly connected to each other and in turn connected to the plasma display panel.

5. The plasma display apparatus as claimed in claim 1, wherein
the energy recovery circuit comprises,
an energy supply/recovery unit for supplying and recovering the energy to/from the plasma display panel; and
an sustain voltage source unit comprising a sustain voltage source, a third switch group and a fourth switch group so that the plasma display panel is applied with a sustain voltage and a ground level voltage.

6. The plasma display apparatus as claimed in claim 5, wherein
the third switch group and the fourth switch group are connected in parallel between the plasma display panel and the energy supply/recovery unit.

7. The plasma display apparatus as claimed in claim 5, wherein
the energy supply/recovery unit comprises,
an inductor for supplying and recovering through the resonance the energy stored in the source voltage source of the plasma display panel, and
a first switch group and a second switch group for performing a switching operation so that the energy is supplied and recovered to the plasma display panel through the inductor.

8. The plasma display apparatus as claimed in claim 7, wherein
the first switch group and the second switch group are connected in parallel between the source voltage source and the inductor.

9. A plasma display apparatus comprising:
a plasma display panel for displaying an image, wherein
the plasma display panel comprises a plurality of energy recovery circuits,
each of the plurality of energy recovery circuit supplies the sustain pulses to the plasma display panel independently to the sustain period of the same sub-field.

10. The plasma display apparatus as claimed in claim 9, wherein
the number of the plurality of energy recovery circuit is two.

11. The plasma display apparatus as claimed in claim 10, wherein
the plurality of energy recovery circuit is composed of a first and a second energy recovery circuits,
the first energy recovery circuit supplies the order-numbered sustain drive pulses to the plasma display panel in a sustain period of the sub-field,
the second energy recovery circuit supplies the even-numbered sustain drive pulses to the plasma display panel in a sustain period of the sub-field.

12. The plasma display apparatus as claimed in claim 11, wherein
the sustain drive pulse input end of the first energy recovery circuit and the sustain drive pulse input end of the second energy recovery circuit are commonly connected to each other and in turn connected to the plasma display panel.

13. The plasma display apparatus as claimed in claim 9, wherein
the energy recovery circuit comprises,
an energy supply/recovery unit for supplying and recovering the energy to the plasma display panel; and
an sustain voltage source unit comprising a sustain voltage source, a third switch group and a fourth switch group so that the plasma display panel is applied with a sustain voltage and a ground level voltage.

14. The plasma display apparatus as claimed in claim 13, wherein
the third switch group and the fourth switch group are connected in parallel between the plasma display panel and the energy supply/recovery unit.

15. The plasma display apparatus as claimed in claim 13, wherein
the energy supply/recovery unit comprises,
an inductor for supplying and recovering through the resonance the energy stored in the source voltage source of the plasma display panel, and
a first switch group and a second switch group for performing a switching operation so that the energy is supplied and recovered to the plasma display panel through the inductor.

16. The plasma display apparatus as claimed in claim 15, wherein
the first switch group and the second switch group are connected in parallel between the source voltage source and the inductor.

17. A driving method of a plasma display apparatus displaying an image by combination of sub-fields, wherein
sustain pulses are supplied to a plasma display panel independently to the sustain period of the different sub-fields among the sub-fields.
